(19) United States
(12) Patent Application Publication
(10) Pub. No.: US 2005/0244720 A1
(43) Pub. Date: Nov. 3, 2005

(54) Recto/verso copy-protected security document

(76) Inventor: Pierre Doublet, Saint-Brice (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/521,555

(22) PCT Filed: Jul. 18, 2003
(86) PCT No.: PCT/FR03/02273

§ 371 Date: Jan. 19, 2005

(30) Foreign Application Priority Data
Jul. 19, 2002 (FR) 02/09221

(51) Int. Cl. G03H 1/04; B42D 15/00

(52) U.S. Cl. 430/1; 430/2; 283/86; 359/2

(57) ABSTRACT

The invention concerns a security document comprising, as security element against recto/verso copying, indicia present on both sides and capable of being viewed under reflected lighting and forming an image capable of being viewed under transmitted light. The invention is characterized in that said indicia comprise lines and form said image with 3D effect.

The invention relates to a security document that includes, as copy protection element, printed lines on both sides of the document that can be observed in reflected light and form an image that can be observed in transmitted light.

To combat the counterfeiting of banknotes by two-sided photocopying or using a scanner and a printer, patterns on the front side and patterns on the reverse side of the banknote have been produced, by suitable registration in a given region, so that these patterns combine to form a final image or representation, for example a set of graphical lines or alphanumeric characters or an image of a person or animal, etc. When the banknote is viewed in reflected light, only the pattern produced on the observed face is seen whereas, when the banknote is observed in transmitted light, all the patterns that therefore combine to give the final representation are seen. According to a variant of these printed indicia, identical patterns are produced on the front side and on the reverse side by superposing them so as to observe, in transmitted light, an image that is also identical to the patterns. These patterns are produced by printing areas of flat tint or by printing lines. A person skilled in the art refers to these as “see-through” indicia or, in the case of the variant, as “print-through” indicia. Certain banknotes have a weight and an opacity that are sufficiently low to allow these patterns to be observed provided that the printed indicia are flat tints and/or not too fine.

To be able to apply these indicia to security documents having a higher weight and/or higher opacity, it has been proposed, in European patent application EP 388 090, to print these indicia in a region of reduced opacity, this region being produced specifically by a watermark obtained in a conventional manner. European patent application EP 687 324 proposes a region of reduced thickness and reduced opacity with an area of more than 0.4 cm² by providing a two-ply paper, one ply of which has a region of reduced or even zero thickness.

Moreover, the means for reproducing the patterns, such as photocopiers and scanners, allow two-sided color copying and have the capability of ever finer resolution; it is therefore endeavored to produce patterns that are more difficult to counterfeit.

However, the Applicant has found that, at the present time, indicia made from flat tints are the most widely used but also are relatively easy to produce by two-sided color photocopiers or scanners. For example, current banknotes of the new European Community currency, namely euros, have, in one of their corners, on both sides of the banknote, printed areas of flat tint with the dominant color of said banknote which indicate the value of the banknote, observable when it is held up to the light. These euro banknotes do not have a region of reduced opacity and the areas of flat tint are quite coarse and could be quite easy to reproduce.

As regards the printing of lines, the abovementioned, European patent application EP 388 090 has described the printing of concentric circles present alternately on the front side and on the reverse side of a sheet, but these circles do not have any particularity and could be quite easily counterfeited by current reproduction means.

The objective of the Applicant is to provide a security document having an enhanced level of security against two-sided copying.

The Applicant proposes to achieve this objective by providing a security document that includes, as security element against two-sided copying, printed indicia present on the front side and on the reverse side that are observable in reflected light and form an image that can be observed in transmitted light, said printed indicia comprising lines and forming said image such that it has a relief and volume effect, i.e. a three-dimensional or 3D effect.

Preferably, the final image that can be observed in transmitted light has a 3D effect obtained by variations in density expressed as number per unit area, and/or variations in printing intensity of the lines. The expression “variations in density expressed as number per unit area” should be understood to mean that the distances between the lines are varied.

Preferably, the lines are present in large number and are very fine.

According to one particular embodiment of the invention, the lines are made from broken lines, in particular discrete dots, i.e. separate dots.

One particular way of producing the lines may be to print the lines such that two adjacent lines of the image are always such that one of the lines is on one side and the next line on the other side.

More generally, another approach may be to print, by means of algorithms, series of lines on one side and their complements on the other. They may be parallel or may intersect. All the lines on the front side and the reverse side may be determined by mathematical means, encryption, etc.

According to a variant of the invention, the printed lines on the front side and on the reverse side are identical and superposed.

The image to be observed when held up to the light may be an image as such, but also part of a larger image or portrait, and in particular one already existing on the document.

More particularly, the lines are black lines and/or in various shades of gray and/or in color and/or they change appearance depending on the viewing angle or under the action of an excitation source, such as radiation, especially fluorescent, thermochromic or photochromic ones, and/or have electromagnetic properties, especially electrically conducting, magnetic or magnetic resonance properties.

The document may also include printed areas of flat tint. Of course, the security document may include other security elements, especially a security thread, flakes, iridescent printing, etc.

More particularly, the invention relates to a banknote.

Preferably, the printed indicia are produced in a region of reduced opacity.

In the case of a paper, this region of reduced opacity may be a region such as that described in patent application EP 687 324, i.e. a region of reduced thickness and reduced opacity with an area of more than 0.4 cm² obtained in a two-ply paper, one ply of which has a region of reduced or even zero thickness.

According to one particular embodiment of the invention, the document is therefore a sheet of two-ply paper, one ply of which includes a region of reduced or even zero thickness and has an area of more than 0.4 cm², this said region having the printed indicia.

According to one particular embodiment of the invention, the document may have, as backing, a plastic sheet or film whose opacity allows the printed indicia to be observed, as in the case of a paper.

Illustrative examples of a security document according to the invention will now be described.

According to a first example, the portrait of a man with a beard, limited to the central part of his face, i.e. his mouth, nose and part of the beard, is produced on a paper. Such an image is formed from lines, the number density of which is varied by varying their spacing; a set of lines is printed on the front side and the complementary set on the reverse side so as to constitute the portrait, which can be seen when held up to the light. The 3D, relief and volume, effect is therefore obtained by the variations in the number density of the lines.

These lines are printed by means of an offset printing machine used to print banknotes and documents of value. These machines can print both sides of a paper that are perfectly in registration with one another, something that an office photocopier or printer (after scanning) can achieve only with limited accuracy. The front side/reverse side printing registration of the portrait makes it possible to achieve a clear, high-quality image that can be observed when held up to the light.

If a counterfeiter attempts two-sided photocopying of this image, he will be unable to bring both sides of the photocopy to accurate registration and therefore the image will no longer be clear—there will then be a mass of lines and the image will no longer be visible when the document is held up to the light. Any unskilled person can thus easily and immediately see that the document or the banknote is counterfeit.

According to a preferred embodiment of this example, this image is produced in a region of reduced opacity. Such a region is produced, for example, like that described in patent EP 687 324.

According to a second example, a sheet of paper is printed with a grid on one side of the sheet and the same grid in correspondence on the reverse side. Since the printing on both sides is in extremely precise registration on machines dedicated to the printing of banknotes and security documents, and since the front side and reverse side grids are in superposition, the image of a single grid with a 3D effect appears when the sheet is observed held up to the light and also when observed in reflected light.

If a counterfeiter were to reproduce these grids by means of a copier or printer (after scanning), there would be a shift of a bar or part of the bars and therefore the grid resulting from the superposition of the two grids on the front side and reverse side would become a clump or even a black square, although when observed in reflected light a grid would be seen on the front side or on the reverse side. Any unskilled person may thus easily and immediately see that the document or banknote is counterfeit.

1. A security document that includes, as security element against two-sided copying, printed indicia present on the front side and on the reverse side that are observable in reflected light and form an image that can be observed in transmitted light, wherein said printed indicia comprise lines and form said image with a 3D effect.

2. The security document as claimed in claim 1, wherein the lines are of variable number density per unit of area and/or variable printing intensity so as to create the 3D effect.

3. The security document as claimed in claim 1, wherein the lines are made from broken lines, in particular discrete dots.

4. The security document as claimed in claim 1, wherein the lines are present in large number and are very fine.

5. The security document as claimed in claim 1, wherein the printed indicia consist entirely of such lines.

6. The security document as claimed in claim 1, wherein the lines are alternately on the front side and on the reverse side, in particular alternating successively on the front side and on the reverse side.

7. The security document as claimed in claim 1, wherein the lines are represented in series, one series of lines being on the front side and its complementary series on the reverse side.

8. The security document as claimed in claim 1, wherein the printed lines on the front side and on the reverse side are identical and superposed.

9. The security document as claimed in claim 1, wherein the lines are generated by an algorithm.

10. The security document as claimed in claim 1, wherein the printed indicia, in particular the lines, include an encryption.

11. The document as claimed in claim 1, wherein the lines are black and/or in various shades of gray and/or in color and/or change appearance depending on the viewing angle or under the action of an excitation source, such as radiation, specially fluorescent, thermochromic or photochromic ones, and/or have electromagnetic properties, especially electrically conducting, magnetic or magnetic resonance properties.

12. The security document as claimed in claim 1, wherein it includes, as support, a paper with a region of reduced opacity and in that said printed indicia are present on the front side and on the reverse side in said region of reduced opacity.

13. The security document as claimed in claim 8, wherein the lines are generated by an algorithm.

14. The security document as claimed in claim 8, wherein the printed indicia, in particular the lines, include an encryption.

15. The document as claimed in claim 8, wherein the lines are black and/or in various shades of gray and/or in color and/or change appearance depending on the viewing angle or under the action of an excitation source, such as radiation, specially fluorescent, thermochromic or photochromic ones, and/or have electromagnetic properties, especially electrically conducting, magnetic or magnetic resonance properties.

16. The security document as claimed in claim 8, wherein it includes, as support, a paper with a region of reduced opacity and in that said printed indicia are present on the front side and on the reverse side in said region of reduced opacity.

17. The security document as claimed in claim 2, characterized in that the printed lines on the front side and on the reverse side are identical and superposed.

18. The security document as claimed in claim 17, wherein the lines are generated by an algorithm.

19. The security document as claimed in claim 17, wherein the printed indicia, in particular the lines, include an encryption.

20. The document as claimed in claim 17, wherein the lines are black and/or in various shades of gray and/or in color and/or change appearance depending on the viewing angle or under the action of an excitation source, such as radiation, specially fluorescent, thermochromic or photochromic ones, and/or have electromagnetic properties, especially electrically conducting, magnetic or magnetic resonance properties.
